(19) United States
(12) Patent Application Publication
(10) Pub. No.: US 2020/0186745 A1
(43) Pub. Date: Jun. 11, 2020

(54) METHOD AND APPARATUS FOR CONVEYANCE OF ZONE BACKLIGHT METADATA FOR HIGH DYNAMIC RANGE

(71) Applicant: INTERDIGITAL VC HOLDINGS, INC., Wilmington, DE (US)

(72) Inventors: Mark Francis RUMREICH, Indianapolis, IN (US); Thomas Edward HORLANDER, Indianapolis, IN (US)

(21) Appl. No.: 16/311,426

(22) PCT Filed: Jun. 28, 2016
(86) PCT No.: PCT/US16/39914

§ 371 Date: Dec. 19, 2018

(51) Int. Cl. H04N 5/57; H04N 21/44; H04N 21/435

(52) U.S. Cl. CPC H04N 5/57; H04N 21/435; H04N 21/44008

(57) ABSTRACT

An array of backlights in a television receiver are controlled through zone backlight metadata to enable better and more artistic control over the backlights. In one embodiment, the zone backlight metadata is sent to a digital receiver in a data channel as part of a digital television signal. In another embodiment, zone backlight metadata is received at the digital television receiver from the internet in coordination with video content. In another embodiment, zone backlight metadata is sent as information on a Blu-Ray disc to control backlights in coordination with the disc's contents.

### TECHNICAL FIELD

The present principles relate to video compression and decompression systems generally and, more particularly to high dynamic range systems.

### BACKGROUND

Digital televisions can use Liquid Crystal Displays (LCDs) or Light Emitting Diodes (LED) displays to generate pictures. Many LCD televisions use LEDs for backlighting. Backlighting is a technique that creates the light for these types of televisions to create images. A backlit television can have LEDs pointing out at the television screen in an array all over the display, or just have LEDs around one or more peripheral edges of the television frame.

The digital televisions can then adjust the brightness of the LEDs to dim areas where darker images are, and light those areas of a scene that are brighter. An apparent increase in dynamic range is experienced by performing this technique. The televisions with backlights all over the screen can use full-array local dimming because they can dim individual LEDs all over the screen. This offers the most control over an entire picture.

More commonly, the LEDs are arranged in various zones all over the screen, each responsible for the brightness of a certain zone. If there are fewer zones, the zones are larger and cannot dim with as much local control as with a larger number of zones. Depending on the number of zones, zone backlighting, as it is known, can be an effective technique of improving the dynamic range of an LED backlit LCD display.

Conventionally, a television supporting zone backlighting analyzes video content and controls its own zone backlighting. However, this type of analysis requires time and resources that may not allow zone backlighting to achieve optimal performance.

### SUMMARY

These and other drawbacks and disadvantages of the prior art are addressed by the present principles, which are directed to a method and apparatus conveyance of zone backlight metadata for high dynamic range.

In one embodiment, a method is provided to convey backlight information comprising steps of deriving zone backlight metadata from video content to control backlights and sending the derived zone backlight metadata to control the backlights.

In another embodiment, an apparatus is provided to convey backlight information comprising a processor to generate backlight control zone backlight metadata and a multiplexer to insert the backlight control signals in a metadata channel.

In another embodiment, a method is provided to control backlights using received zone backlight metadata, comprising receiving the zone backlight metadata and controlling the backlights of a television receiver using the received zone backlight metadata.

In another embodiment, an apparatus is provided to control backlights using received zone backlight metadata comprising a receiver and a controller to control an array of backlights of a television receiver.

### BRIEF DESCRIPTION OF THE DRAWINGS

FIG. 1 shows one embodiment of a method for conveying backlight information using the present principles.

FIG. 2 shows one embodiment of an apparatus for conveying backlight information using the present principles.

FIG. 3 shows one embodiment of a method for receiving backlight information using the present principles.

FIG. 4 shows one embodiment of an apparatus for receiving backlight information using the present principles.

### DETAILED DESCRIPTION

High Dynamic Range (HDR) displays and HDR content will become more prevalent with the advent of Ultra HD Blu-ray and other advanced video technologies. HDR content pushes display brightness to the extremes. But if done improperly, display elements can be overdriven or damaged, and result in poor display quality.

Typically, local dimming is performed using zones of an image, where individual dimming of zones of the television screen is possible and the LEDs associated with a zone are dimmed when needed. Traditional televisions analyze video content and control their own zone backlighting. Zone backlighting with local dimming can achieve an increase in the contrast ratio of images to make them look better.

An improved method, described herein, is to convey zone backlighting on a local basis through metadata. The metadata can be sent from a provider, for example. The described embodiments provide advantages over other approaches. For example, a content provider can anticipate future scene content and adjust the zone backlighting to the scene. A content provider therefore has more artistic control over the scene than using traditional backlighting techniques. It is not possible for a television to determine artistic control elements without metadata. Zone specific backlight metadata would allow producers to create dynamic range effects otherwise not achievable.

Although it can be practical for a television to buffer and analyze future scenes, it isn't practical to the extent that is possible with preprocessed metadata. The thermal time constant of backlight elements can require analyzing content many seconds into the future to maximize dynamic range.

In addition, because a backlighting algorithm is a complex, processor intensive operation, it can be implemented before a signal is sent from a content provider, so that more complex algorithms can be used in a studio. Such an embodiment enables better backlighting with a simpler television receiver. Metadata for zone-specific motion blur compensation, for example at 120 or 240 Hz, would also benefit from zone backlight metadata for similar reasons.

Zone specific metadata use for conveyance of backlight information depends on the type of the source content and on the display technology. It is of most use when it transforms non-HDR content to HDR on a true HDR display. Metadata can also transform non-HDR content to pseudo HDR when used on a pseudo HDR display. Tone mapping or equivalent metadata would also need to be conveyed. A pseudo HDR display is one, for example, that uses high resolution zone backlighting.

Backlight metadata can also enhance the dynamic range of a pseudo HDR display when displaying HDR content. However, it is of more limited value when displaying HDR content on true HDR displays. These situations are summarized in Table 1.

TABLE 1

| content type | display technology | metadata use |
|---|---|---|
| HDR content | true HDR display | of limited value |
| HDR content | pseudo HDR display | enhances the dynamic |
| | (high res zone backlit) | range of the display |
| non-HDR content | true HDR display | can transform content |
| | | to HDR |
| non-HDR content | pseudo HDR display | can transform content |
| | (high res zone backlit) | to pseudo HDR |

The zone-specific metadata for conveyance of backlight information can take one of several formats. The format can be specific to a television model or a generic format. Model specific metadata can contain fields for manufacturer codes, model codes, and frame reference numbers along with metadata for the backlight information. Therefore, the metadata can be specific to a particular brand and model.

Examples of fields of metadata that can be used for this application are shown in Table 2.

TABLE 2

| Name | description |
|---|---|
| ave_brightness | Array of average picture brightness versus picture |
| [i] | index for the entire image. Allows anticipation of |
| | power supply and backlight element loading. |
| region_size | Defines the width and height of a display region |
| [xmax, ymax] | |
| ave_brightness | Array of average picture brightness versus picture |
| [I, x, y] | index by display region. The x, y coordinates |
| | define the top left point of an xmax wide by ymax |
| | high display region. Allows anticipation of power |
| | supply and backlight element loading. |
| ave_brightness | Array of average picture brightness versus picture |
| [I, rgb] | index for the entire image by color primary. Allows |
| | anticipation of power supply and backlight element |
| | loading. |
| peak_brightness | Array of peak picture brightness versus picture |
| [i] | index for the entire image. Allows anticipation of |
| | power supply and backlight element loading. |
| peak_brightness | Array of peak picture brightness versus picture |
| [I, x, y] | index by display region. The x, y coordinates define |
| | the top left point of an xmax wide by ymax high |
| | display region. Allows anticipation of power supply |
| | and backlight element loading. |
| peak_brightness | Array of peak picture brightness versus picture |
| [I, rgb] | index for the entire image by color primary. Allows |
| | anticipation of power supply and backlight element |
| | loading. |

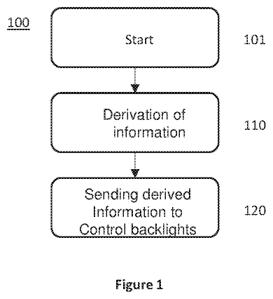

One embodiment of a method 100 for conveying zone backlight metadata is shown in FIG. 1. The method commences at block 101 and proceeds to block 110 for deriving zone backlight metadata associated with video content. Control proceeds from block 110 to block 120 for sending the derived zone backlight metadata for controlling backlights to a television receiver. The zone backlight metadata can be sent as metadata in a digital television signal. It can be sent as side information on a disc of video content, for example. Or, the zone backlight metadata can be sent in a number of other channels.

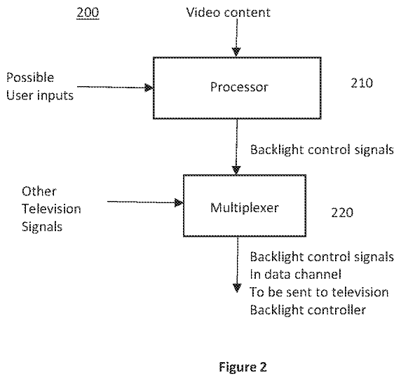

One embodiment of an apparatus 200 for conveying zone backlight metadata is shown in FIG. 2. The apparatus comprises a processor 210 to derive zone backlight metadata associated with video content. Processor 210 receives video content on one of its input ports. It can also receive user inputs on a second port, such as artistic inputs related to the video content, or information from another database, for example. The output of processor 210 is in signal connectivity with a first input of multiplexer 220. A second input of multiplexer 220 can receive other television signals. An output of multiplexer 220 sends zone backlight metadata to control backlights to a television receiver, such as in a separate data channel, as metadata, or in another place on a disc, such as a Blu-Ray disc, for example.

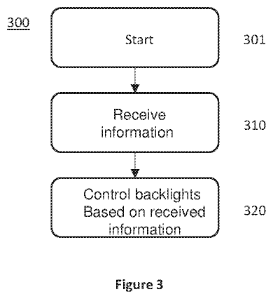

Another embodiment of a method 300 for controlling backlights in a television receiver is shown in FIG. 3. The method commences at block 301 and proceeds to block 310 for receiving zone backlight metadata associated with video content. The received zone backlight metadata can come from a separate data channel in a digital television signal, a separate part of a Blu-Ray disc, or from the internet, for example. The method proceeds from block 310 to block 320 for controlling backlights in a television receiver using the received zone backlight metadata.

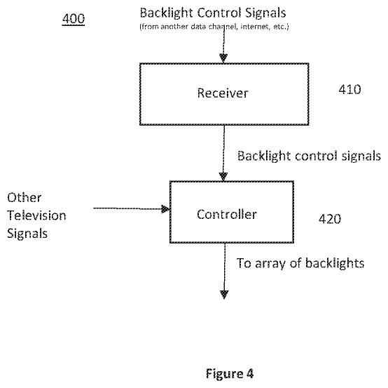

Another embodiment of an apparatus 400 for controlling backlights is shown in FIG. 4. The apparatus comprises a receiver 410 that receives zone backlight metadata associated with video content on its input. The received zone backlight metadata can come from a separate data channel in a digital television signal, a separate part of a Blu-Ray disc, or from the internet, for example. The output of receiver 410 is in signal connectivity with a first input of Controller 420. A second input of Controller 420 can receive other television signals on a second input port. Controller 420 adjusts the backlights in a television receiver using the received zone backlight metadata, which can be coordinated with the other television signals.

Zone backlight metadata can accompany streaming content. Or, it could reside on a Blu-Ray Disc (BD) for use with the disc content. In an alternate embodiment, zone backlight metadata can be located on an internet database, accessible by a BD player or television receiver, which would provide several advantages. First, it could be updated when new receiver models are introduced. An internet database would eliminate the storage limitations of having it on a disc. Also, it could be updated when new or improved metadata information becomes available. It could also be separately sellable. Such an internet database could also be used for streaming content. It could be maintained by a studio, a product manufacturer, or a third-party content aggregator.

The aforementioned embodiments can be implemented in Set Top Boxes (STBs), modems, gateways or other devices that perform video encoding or decoding.

The functions of the various elements shown in the figures can be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

1. A method for conveying zone backlight metadata, comprising:
deriving zone backlight metadata associated with video content; and,
sending said derived zone backlight metadata for controlling backlights to a television receiver.

2. The method of claim 1, wherein sending said derived zone backlight metadata comprises inserting the derived zone backlight metadata in a digital television signal.

3. The method of claim 1, wherein deriving zone backlight metadata comprises an offline process.

4. An apparatus for conveying zone backlight metadata, comprising:
a processor to derive zone backlight metadata associated with video content; and,
a multiplexer to send zone backlight metadata to control backlights to a television receiver.

5. The apparatus of claim 4, wherein said multiplexer inserts the derived zone backlight metadata in a digital television signal.

6. The apparatus of claim 4, wherein said processor derives zone backlight metadata using an offline process.

7. A method for controlling backlights, comprising:
receiving zone backlight metadata associated with video content; and,
controlling backlights in a television receiver using said received zone backlight metadata.

8. The method of claim 7, wherein said received zone backlight metadata is metadata in a digital television signal.

9. An apparatus for controlling backlights, comprising:
a receiver of zone backlight metadata associated with video content; and,
a controller of backlights in a television receiver that uses said received zone backlight metadata.

10. The apparatus of claim 9, wherein said receiver gets said zone backlight metadata as metadata in a digital television signal.

11. A non-transitory computer readable storage medium having stored thereon instructions for controlling backlights in a television receiver.

12. A non-transitory computer readable storage medium having stored thereon a bitstream for controlling backlights in a television receiver.
